(19) United States
(12) Patent Application Publication
(10) Pub. No.: US 2026/0332510 A1
(43) Pub. Date: Oct. 22, 2026

(54) NETWORK SHARING SYSTEM AND DATA SCHEDULING METHOD THEREOF

(71) Applicant: Nanning FuLian FuGui Precision Industrial Co., Ltd., Nanning (CN)

(72) Inventors: SHENG-XIONG WEI, Nanning (CN); Hui-Jia Zhou, Shenzhen (CN)

(21) Appl. No.: 19/214,328

(22) Filed: May 21, 2025

(30) Foreign Application Priority Data
Apr. 17, 2025 (CN) 202510486952.7

(51) Int. Cl. H04L 45/12

(52) U.S. Cl. CPC H04L 45/124

(57) ABSTRACT

A method and device for Data Scheduling, comprising, a processing module configured to determine multiple transmission paths between a first interface unit and a second interface unit. Upon receiving pending transmission data from the first interface unit, the processor module estimates a shortest-time transmission path or a maximum-throughput transmission path for outputting the total data volume of the pending transmission data from multiple transmission paths. The processing module controls the pending transmission data to the second interface unit via either the shortest-time transmission path or the maximum-throughput transmission path.

### FIELD

The subject matter herein generally relates to a field of wireless communication technologies, particularly a network sharing system and data scheduling method thereof.

### BACKGROUND

A Radio Unit (RU) is responsible for transmitting and receiving wireless signals in a 5G network, and for conducting wireless communication with terminal devices such as mobile phones and Internet of Things (IoT) devices. The RU typically works in conjunction with a Distributed Unit (DU). The RU converts digital signals received from the DU into radio frequency (RF) signals and transmits them through its antennas. Conversely, the RU also converts RF signals received from its antennas into digital signals and forwards them to the DU.

To enable more efficient utilization of the network, a Shared Open Radio Unit (Shared O-RU) has been developed. The Shared O-RU is a hardware device. In addition to cooperating with terminals and DUs, the Shared O-RU can also provide access to multiple different radio access networks. For example, the Shared O-RU allows different service providers to share access resources in order to support diverse services and business requirements, thereby reducing costs and improving efficiency.

Since a Shared O-RU must handle a large volume of data from multiple access networks, the absence of proper data scheduling may lead to frequent task switching, which can prevent the system from achieving optimal performance.

Accordingly, there is a need for a network sharing system and data scheduling method thereof, which can efficiently schedule data based on current conditions, enabling either minimum-time data processing or maximum-volume data processing under optimal conditions.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic diagram of an embodiment of a network sharing system.

FIG. 2 is a flowchart of an embodiment of a method for data scheduling in a network sharing system.

FIG. 3 is a schematic diagram of an embodiment of a plurality of transmission paths.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to;” it specifically indicates open-ended inclusion or membership in the so-described combination, group, series, and the like.

The present invention relates to a network sharing system and data scheduling method thereof, which can effectively schedule transmitted data based on the current situation. It can process data in the minimum time or process the maximum amount of data under optimal conditions at once.

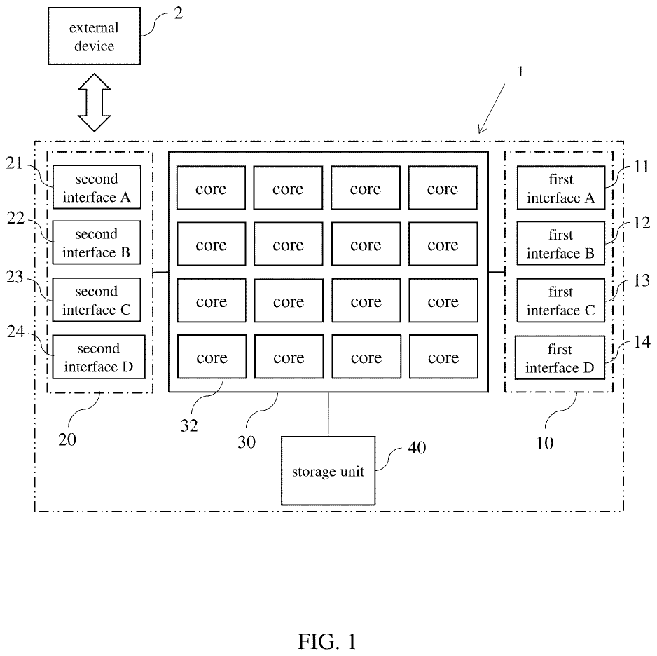

The method for data scheduling of the present embodiment can be applied in a network sharing system to efficiently schedule data transmitted from various vendors to the network sharing system. Please refer to FIG. 1, the network sharing system 1 of the present embodiment is a Shared Open Radio Unit (Shared O-RU), and the network sharing system 1 is connected to an external device 2. In this embodiment, the external device 2 may be a Distributed Unit (DU). The network sharing system 1 receives data from different vendors and forwards the data to the external device 2. The network sharing system 1 may also transmit data received from the external device 2 to external destinations.

The network sharing system 1 includes a first interface unit 10, a second interface unit 20, a processing module 30, and a storage unit 40. In this embodiment, the processing module 30 is connected to the first interface unit 10 (including a first interface A 11, a first interface B 12, a first interface C 13, and a first interface D 14), the second interface unit 20 (including a second interface A 21, a second interface B 22, a second interface C 23, and a second interface D 24), and the storage unit 40. The processing module 30 is configured to control each of the first interface A 11, first interface B 12, first interface C 13, and first interface D 14 of the first interface unit 10, and each of the second interface A 21, second interface B 22, second interface C 23, and second interface D 24 of the second interface unit 20 to transmit or receive messages.

In this embodiment, the first interface unit 10 may be a Radio Frequency (RF) antenna device, configured to receive or transmit RF signals. The second interface unit 20 may be a port, such as a high-speed (25G) output port, an RJ45 (Registered Jack 45) interface, or a USB (Universal Serial Bus) port. The network sharing system 1 is connected to the external device 2 through the second interface unit 20.

In this embodiment, the first interface unit 10 serves as the data input port, and the second interface unit 20 serves as the data output port. The processing module 30 is configured to determine multiple transmission paths for transmitting data from the first interface unit 10 to the second interface unit 20. In this embodiment, the first interface unit 10 includes first interfaces A11, B12, C13, and D14, and the second interface unit 20 includes second interfaces A21, B22, C23, and D24, resulting in a total of sixteen possible transmission paths. The processing module 30 can estimate the optimal transmission path for transmitting data, so that the data can be delivered to the external device 2 in an optimized manner. For example, the first interface unit 10 can receive data from different vendors and transmit data to the external device 2 via the second interface unit 20. The second interface unit 20 may also receive data from the external device 2 and transmit it outward via the first interface unit 10.

The processing module 30 may be a multi-core processor, and the processing module 30 includes a plurality of cores 32. The plurality of cores 32 are each used to control the first interface unit 10, the second interface unit 20, and to estimate the data scheduling for data transmission. Through the plurality of cores 32, the first interface unit 10, the second interface unit 20, and the estimation of data scheduling for data transmission can be controlled simultaneously, thereby effectively improving the utilization efficiency of the network sharing system 1.

The storage unit 40 may be a memory or hard drive, used to store information such as the linear programming algorithm for estimating the scheduling of data, the transmission time (processing time parameters) for each transmission path, and the maximum transmission capacity of each transmission path. The storage unit 40 may also store information regarding the data volume input to or output from the network sharing system 1, such as the data volume input to or output from each first interface unit 10 or second interface unit 20.

FIG. 1 is merely an example and should not be construed as a limitation of the present invention. For example, the number of first interface units 10 or second interface units 20 may also be plural; additional processing modules 30, cores 32, and storage units 40 may also be deployed.

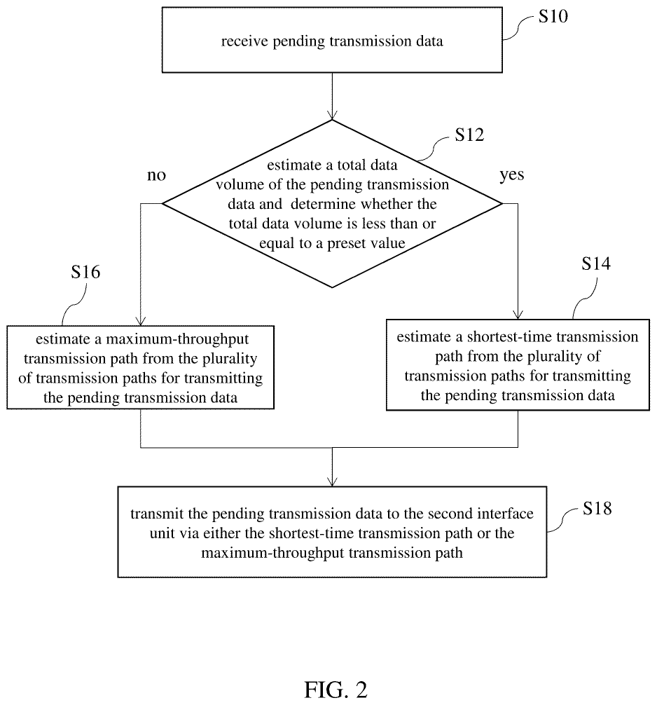

Please refer to FIG. 2, which illustrates a method by which the processing module 30 estimates the optimal data transmission path for performing data scheduling. In this embodiment, a portion of the cores 32 in the processing module 30 are used to execute the data scheduling method.

First, in step S10, the network sharing system 1 receives pending transmission data through the first interface unit 10. In this embodiment, the first interfaces A11, B12, C13, and D14 may respectively receive data from different vendors, which becomes the pending transmission data. The first interface unit 10 delivers the pending transmission data to the processing module 30. The pending transmission data may be radio frequency (RF) signals.

After receiving the pending transmission data, the processing module 30 uses a portion of the cores 32 to convert the radio frequency (RF) pending transmission data into digital signals. In step S12, a portion of the cores 32 estimates the total data volume of the pending transmission data and determines whether the total data volume of the pending transmission data is less than or equal to a preset value. The total data volume corresponds to all the data received at input port unit 10, and the total data volume of the pending transmission data stored in the storage unit 40. The preset value corresponds to the data volume that the second interface unit 20 can transmit at one time. The preset value is obtained by previously measuring the data transmission capability of the second interface units 20, and the preset value is stored in the storage unit 40.

If, in step S12, it is yes, determined that the total data volume of the pending transmission data is less than or equal to the preset value, the process proceeds to step S14, in which the processing module 30 estimates the shortest-time transmission path from the plurality of transmission paths for transmitting the volume of the pending transmission data.

If, in step S12, it is no, determined that the total data volume of the pending transmission data is greater than the preset value, the process proceeds to step S16, in which the processing module 30 estimates the maximum-throughput transmission path from the plurality of transmission paths for transmitting the volume of the pending transmission data.

The process proceeds to step S18, where the processing module 30 controls the pending transmission data to be transmitted to the second interface unit 20 via the shortest time transmission path or the maximum-throughput transmission path.

With reference to FIG. 1, step S14 is described in detail. In step S14, the processing module 30 estimates the shortest-time transmission path for transmitting the total output data volume from multiple transmission paths. The shortest-time transmission path is estimated based on the processing time parameters of each transmission path and the first constraint. By inputting the processing time parameters and the first constraint into a linear programming algorithm, the shortest-time transmission path is estimated. The processing time parameters for each transmission path are obtained by previously measuring the processing time of each path, and after measurement, they are stored in the storage unit 40.

TABLE 1

| | first | first | first | first |
|---|---|---|---|---|
| | interface A | interface B | interface C | interface D |
| second | 3 ms | 11 ms | 3 ms | 10 ms |
| interface A | | | | |
| second | 1 ms | 9 ms | 2 ms | 8 ms |
| interface B | | | | |
| second | 7 ms | 4 ms | 10 ms | 5 ms |
| interface C | | | | |
| second | 6 ms | 5 ms | 9 ms | 6 ms |
| interface D | | | | |

Table 1 is used to represent the processing time parameters of the transmission paths stored in the storage unit 40, indicating the time processing parameters for each first interfaces A11, B12, C13, and D14 to transmit data to each second interface A21, B22, C23, and D24. For example, the processing time parameter for data transmission from first interface A11 to second interface A21 is 3 milliseconds (ms), and the processing time parameter for data transmission from first interface A11 to second interface B22 is 11 ms, and so on.

The first constraint includes that the data volume output from the first interface unit 10 must be less than or equal to the data volume input to the first interface unit 10; the data volume output from the second interface unit 20 must be less than or equal to the preset output volume; and the data transmitted along each transmission path must be greater than or equal to zero. The preset output volume refers to the data volume that the second interface unit 20 can output, and this preset output volume can be obtained through prior measurement of the second interface unit 20. The preset output volume is stored in the storage unit 40.

TABLE 2

| | second | second | second | second |
|---|---|---|---|---|
| | interface A | interface B | interface C | interface D |
| the transmission | 3 G | 6 G | 5 G | 6 G |
| capacity of the | | | | |
| second interface | | | | |

Table 2 shows the default transmission capacity of each second interface (A21, B22, C23, D24). The processing module 30 receives the pending transmission data to estimate the data volume received by each first interface (A11, B12, C13, D14) and records the data volume of each interface in the storage unit 40. As shown in Table 3, which indicates the data volume currently input to each first interface (A11, B12, C13, D14).

TABLE 3

| | first | first | first | first |
|---|---|---|---|---|
| | interface A | interface B | interface C | interface D |
| the pending data | 5 G | 4 G | 7 G | 4 G |
| volume of the first | | | | |
| interface | | | | |

This describes how the processing module 30 estimates the shortest-time transmission path based on the processing time parameters of the transmission paths and the first constraint condition. First, the processing module 30 obtains the processing time parameters of the transmission paths and substitutes them into the objective function equation of the linear programming algorithm:

Min Z=c₁X₁₁+c₂X₁₂+ . . . +cₙXᵢⱼ

The cₙ is the processing time parameters, the xᵢⱼ is the transmission paths. Reference to the parameters in Table 1, the substitution is expressed as follows:

Min Z=3X₁₁+11X₁₂+3X₁₃+10X₁₄+1X₂₁+9X₂₂+2X₂₃+8X₂₄+7X₃₁+4X₃₂+10X₃₃+15X₃₄+6X₄₁+5X₄₂+9X₄₃+6X₄₄

The processing module 30 sets the first constraint condition. The data volume output from each of the first interfaces A11, B12, C13, and D14 must be less than or equal to the data volume input to each of the corresponding first interfaces A11, B12, C13, and D14. With reference to the parameters in Table 3, the constraint is expressed in the form of equations as follows:

X₁₁+X₁₂+X₁₃+X₁₄≤5

X₂₁+X₂₂+X₂₃+X₂₄≤4

X₃₁+X₃₂+X₃₃+X₃₄≤7

X₄₁+X₄₂+X₄₃+X₄₄≤4

The data volume output from each of the second interfaces A21, B22, C23, and D24 must be less than or equal to the preset output volume. With reference to the parameters in Table 2, the constraint is expressed as follows:

X₁₁+X₁₂+X₁₃+X₁₄≤3

X₂₁+X₂₂+X₂₃+X₂₄≤6

X₃₁+X₃₂+X₃₃+X₃₄≤5

X₄₁+X₄₂+X₄₃+X₄₄≤6

The data volume transmitted through each transmission path must be greater than or equal to zero, which can be expressed by the following equation:

Xij>=0 (i=1,2,3,4; j=1,2,3,4)

After the processing module 30 inputs the transmission path processing time parameters and the first constraint conditions into a linear programming algorithm, it can calculate the shortest-time transmission path, which is the optimal path that enables all data to be transmitted in the shortest possible time.

Next, the implementation of estimating the maximum-throughput transmission path for transmitting the total data volume in step S16 using the linear programming algorithm is described in detail. The maximum-throughput transmission path is estimated based on the maximum transmission capacities of the transmission paths and the second constraint conditions. The maximum transmission capacities of each transmission path is measured in advance and stored in the storage unit 40.

TABLE 4

| | second | second | second | second |
|---|---|---|---|---|
| | interface A | interface B | interface C | interface D |
| first interface | 3 Gbps | — | 3 Gbps | 10 Gbps |
| A | | | | |
| first interface | 1 Gbps | — | — | 8 Gbps |
| B | | | | |
| first interface | 7 Gbps | 4 Gbps | — | 5 Gbps |
| C | | | | |
| first interface | 6 Gbps | — | 9 Gbps | 6 Gbps |
| D | | | | |

Table 4 is used to represent the maximum transmission capacity of the transmission paths stored in the storage unit 40. It indicates the maximum transmission capacity for each first interface A11, B12, C13, D14 transmitting data to each second interface A21, B22, C23, D24. For example, the maximum transmission capacity of the transmission path from the first interface A11 to the second interface A21 is 3 Gbps. The first interface A11 cannot transmit to the second interface B22. The maximum transmission capacity of the transmission path from the first interface A11 to the third interface A23 is 3 Gbps, and so on.

The second constraint condition includes constraining the flow of a virtual input node and a virtual output node. The data volume input to the first interface equals the data volume output from the first interface. The data volume input to the second interface equals the data volume output from the second interface. The data volume transmitted through the transmission path is less than or equal to the preset data volume. The data volume transmitted along the transmission path is greater than or equal to zero.

The virtual input point is a virtual starting point that provides data, from which data is input to the first interface unit 10. The virtual output point is a virtual endpoint that receives data output from the second interface unit 20.

The preset output volume refers to the amount of data that the second interface unit 20 can output. The preset output volume can be determined in advance by measuring each of the second interfaces A21, B22, C23, and D24. The measured output volume is stored in the storage unit 40.

TABLE 5

| | second | second | second | second |
|---|---|---|---|---|
| | interface A | interface B | interface C | interface D |
| the transmission | 3 G | 6 G | 5 G | 6 G |
| capacity of the | | | | |
| second interface | | | | |

Table 5 shows the preset output data volumes for each of the second interfaces A21, B22, C23, and D24. When the processing module 30 receives the pending transmission data and estimates its data volume, it can also record the data volume received by each of the first interfaces A11, B12, C13, and D14 in the storage unit 40. This is represented as shown in Table 6, which indicates the current input data volumes for each of the first interfaces A11, B12, C13, and D14.

TABLE 6

| | first | first | first | first |
|---|---|---|---|---|
| | interface A | interface B | interface C | interface D |
| the pending data | 8 G | 4 G | 7 G | 4 G |
| volume of the first | | | | |
| interface | | | | |

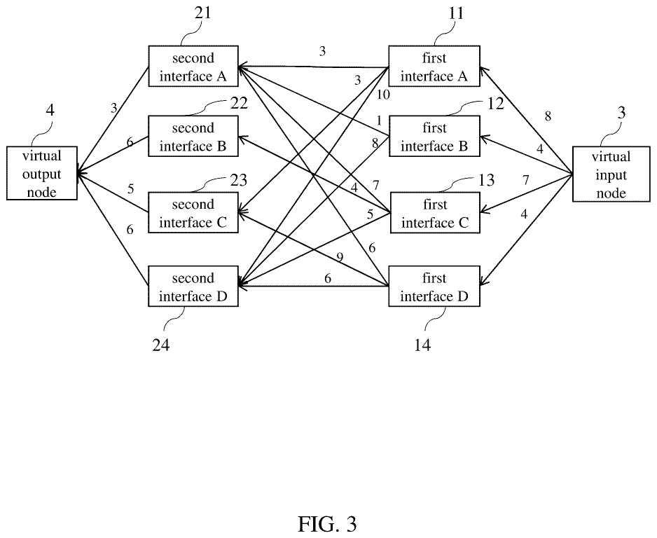

The following describes how the processing module 30 estimates the maximum-throughput transmission path based on the maximum transmission capacities of the transmission paths and the second constraint condition. To facilitate computation, the processing module 30 sets a virtual input point and a virtual output point. Please refer to FIG. 3, the virtual input point 3 inputs data to the first interfaces A11, B12, C13, and D14, respectively. The first interfaces A11, B12, C13, and D14 are connected to the second interfaces A21, B22, C23, and D24, respectively, forming transmission paths. The second interfaces A21, B22, C23, and D24 are further connected to the virtual output point 4. For clarity, the data volumes transmitted along the paths from Table 4-6 are illustrated in FIG. 3.

The output data volume parameters from Tables 4-6 are incorporated into the objective function equation of the linear programming formulation, as follows:

Max Z=8fₛ₁+4fₛ₂+7fₛ₃+4fₛ₄+3f₁₁+3f₁₃+10f₁₄+1f₂₁+8f₂₄+7f₃₁+4f₃₂+5f₃₄+6f₄₁+9f₄₃+6f₄₄+3f_{1E}+6f_{2E}+5f_{3E}+6f_{4E}

The f is transmission paths, the S is virtual input point, the E is virtual output point. For example, in the case of 8fₛ₁, the fₛ₁ represents the data transmitted from virtual input point 3 to the first interface A11, and the number 8 refers to the data volume transmitted from the virtual input point 3 to the first interface A11 as shown in Table 6. f₁₁ represents the data transmitted from the first interface A11 to the second interface A21, and the number 3 refers to the data volume transmitted from the first interface A11 to the second interface A21 as shown in Table 4.

Next, the processing module 30 sets the second constraint condition. The second constraint condition includes constraining the flow between virtual input point 3 and virtual output point 4. In this embodiment, based on Table 6, the total data volume transmitted to the first interfaces A11, B12, C13, and D14 is summed, and can be expressed in the following equation:

8+4+7+4=23 G

In this embodiment, based on Table 5, the total data volume output from all of the second interfaces A21, B22, C23, and D24 to the virtual output point 4 is summed, and can be expressed in the following equation:

3+6+5+6=20 G

The second constraint condition further includes that the total data volume input to the first interfaces A11, B12, C13, and D14 should be equal to the data volume output from the first interfaces A11, B12, C13, and D14. The data volume input to the second interfaces A21, B22, C23, and D24 should be equal to the data volume output from the second interfaces A21, B22, C23, and D24. The data volume transmitted through each transmission path must be less than or equal to a preset data volume, where the preset data volume is the maximum throughput of each transmission path. The data volume transmitted through each transmission path must be greater than or equal to zero. This can be expressed by the following equations:

Xij>=0 (i=1,2,3,4; j=1,2,3,4)

After the processing module 30 inputs the maximum transmission capacities of the transmission paths and the second constraint condition into the linear programming algorithm, the maximum-throughput transmission path can be calculated. This is the optimal transmission path that can transmit the maximum amount of data in a single instance.

As described above, the present invention effectively schedules large volumes of data based on the current conditions, enabling data to be processed in the shortest possible time while maximizing the data throughput under optimal conditions.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for data scheduling in a network sharing system, the network sharing system comprising a processing module, a first interface unit, and a second interface unit, the method comprising:
determining, by the processing module, to a plurality of transmission paths between the first interface unit and the second interface unit;
receiving, by the processing module, pending transmission data from the first interface unit;
estimating, by the processing module, a total data volume of the pending transmission data and determining, by the processing module, whether the total data volume is less than or equal to a preset value;
estimating, by the processing module, a shortest-time transmission path from the plurality of transmission paths for transmitting the total data volume when the total volume is less than or equal to the preset value;
estimating, by the processing module, a maximum-throughput transmission path from the plurality of transmission paths for transmitting the total data volume when the total volume is larger than the preset value; and
transmitting, by the processing module, the pending transmission data to the second interface unit via either the shortest-time transmission path or the maximum-throughput transmission path.

2. The method of claim 1, wherein the shortest-time transmission path is estimated by applying a linear programming algorithm using processing time parameters of the plurality of transmission paths and a first constraint condition.

3. The method of claim 2, wherein the first constraint condition comprises: a data volume output from the first interface unit is less than or equal to a data volume input to the first interface unit; a data volume output from the second interface unit is less than or equal to a preset output volume; and a data volume transmitted through each of the plurality of transmission paths is greater than or equal to zero.

4. The method of claim 1, wherein the maximum-throughput transmission path if estimated by applying a linear programming algorithm using maximum transmission capacities of the plurality of transmission paths and a second constraint condition to determine the maximum-throughput transmission path.

5. The method of claim 4, wherein the second constraint condition comprises: constraining a flow of a virtual input node and a virtual output node; the data volume input to the first interface unit is equal to the data volume output from the first interface unit; the data volume input to the second interface unit is equal to the data volume output from the second interface unit; the data volume transmitted through each of the plurality of transmission paths is less than or equal to a preset data volume; and the data volume transmitted through each of the plurality of transmission paths is greater than or equal to zero.

6. The method of claim 1, wherein the first interface unit comprises: a plurality of first interfaces; the second interface unit comprises a plurality of second interfaces; and the plurality of transmission paths are established between the plurality of first interfaces and the plurality of second interfaces.

7. A network sharing system, comprises:
a first interface unit configured to receive a pending transmission data;
a second interface unit configured to output the pending transmission data;
a processing module coupled to the first interface unit and the second interface unit, the processing module configured to:
determine a plurality of transmission paths between the first interface unit and the second interface unit;
receive the pending transmission data from the first interface unit to estimate a total data volume of the pending transmission data and to determine whether the total data volume is less than or equal to a preset value;
estimate a shortest-time transmission path from the plurality of transmission paths for transmit the total data volume when the total data volume is less than or equal to the preset value;
estimate a maximum-throughput transmission path from the plurality of transmission paths for transmit the total data volume when the total data volume is greater than the preset value;
transmit the pending transmission data to the second interface unit via either the shortest-time transmission path or the maximum-throughput transmission path.

8. The system of claim 7, wherein the processing module estimates the shortest-time transmission path comprises applying a linear programming algorithm using processing time parameters of the plurality of transmission paths and a first constraint condition.

9. The system of claim 8, wherein the first constraint condition comprises: a data volume output from the first interface unit is less than or equal to a data volume input to the first interface unit; a data volume output from the second interface unit is less than or equal to a preset output volume; and a data volume transmitted through each of the plurality of transmission paths is greater than or equal to zero.

10. The system of claim 7, wherein the processing module estimates the maximum-throughput transmission path comprises applying a linear programming algorithm using maximum transmission capacities of the plurality of transmission paths and a second constraint condition.

11. The system of claim 10, wherein the second constraint condition comprises: constraining a flow of a virtual input node and a virtual output node; the data volume input to the first interface unit is equal to the data volume output from the first interface unit; the data volume input to the second interface unit is equal to the data volume output from the second interface unit; the data volume transmitted through each of the plurality of transmission paths is less than or equal to a preset data volume; and the data volume transmitted through each of the plurality of transmission paths is greater than or equal to zero.

12. The system of claim 7, comprising a storage unit coupled to the processing module, the storage unit storing a linear programming algorithm, processing time parameters of the plurality of transmission paths, and the maximum transmission capacities of the plurality of transmission paths.

13. The system of claim 7, wherein the first interface unit comprises a plurality of first interfaces; the second interface unit comprises a plurality of second interfaces; and the plurality of transmission paths are established between the plurality of first interfaces and the plurality of second interfaces.

14. The system of claim 7, wherein the processing module is a multi-core processor.

15. A network sharing system, comprises:
a processor configured to:
receive pending transmission data;
estimate a total data volume of the pending transmission data and to determine whether the total data volume is less than or equal to a preset value;
estimate a shortest-time transmission path from a plurality of transmission paths for transmit the total data volume when the total data volume is less than or equal to the preset value;
estimate a maximum-throughput transmission path from the plurality of transmission paths for transmit the total data volume when the total data volume is greater than the preset value; and
transmit the pending transmission data to the second interface unit via either the shortest-time transmission path or the maximum-throughput transmission path.
